(19) United States
(12) Patent Application Publication
(10) Pub. No.: US 2026/0212068 A1
(43) Pub. Date: Jul. 23, 2026

(54) SYSTEMS AND METHODS FOR INDUSTRIAL WASTE CONTAINERS

(71) Applicant: ATKINS ENERGY PRODUCTS & TECHNOLOGY, LLC, Tampa, FL (US)

(72) Inventors: Timothy Nicholas MILNER, Tampa, FL (US); Mark MORANT, Tampa, FL (US); Aditya NARAYANAN, Tampa, FL (US); Stephan TRUDEAU, Tampa, FL (US); Robert WYATT, Tampa, FL (US)

(21) Appl. No.: 19/139,774

(22) PCT Filed: Dec. 15, 2023
(86) PCT No.: PCT/US2023/084387

§ 371 Date: Jun. 16, 2025

Related U.S. Application Data
(60) Provisional application No. 63/433,352, filed on Dec. 16, 2022.

(51) Int. Cl. G06F 30/20; B29C 64/393; B33Y 50/02; B33Y 80/00; G06F 113/10; G06F 119/18

(52) U.S. Cl. CPC G06F 30/20; B29C 64/393; B33Y 50/02; B33Y 80/00; G06F 2113/10; G06F 2119/18

(57) ABSTRACT

A method for manufacturing a site-optimized storage container includes: for at least one waste product at an industrial site, obtaining location data and waste characteristic data; generating or obtaining parameter/characteristic data for a least one wastestream for the at least one waste product; based on the wastestream parameters and location data, determining at least one material for storing the waste; and generating an optimized container design based on the at least one material and storage facility data. A storage container is manufactured base on this design. A complete digital record of the custom design parameters, testing and/or lifespan measurements of each container is maintained.

### CROSS-REFERENCE TO RELATED APPLICATIONS

This application claims all benefit including priority to U.S. Provisional Patent Application 63/433,352, filed Dec. 16, 2022, and entitled “SYSTEMS AND METHODS FOR INDUSTRIAL WASTE CONTAINERS,” the entirety of which is hereby incorporated by reference.

### FIELD

Aspects of the present specification relate to the field of industrial waste containers, and in particular, aspects of the present specification relate to systems and methods for shape optimised waste containers for radioactive waste.

### BACKGROUND

The operation of nuclear power plants produces radioactive waste that must be disposed of safely and securely for many 1000s of years. The regulations are stringent, with strict restrictions on the strength and performance required to qualify any component with a safety function. The hazard posed by release of radioactive waste means that it is in the best interests of all stakeholders to keep required storage to a minimum. Moreover, the high costs associated with manufacturing a container that is safe for use means that reduction in storage.

Storage facilities are complex, depending as much on local geography as they on available resources and the regulatory framework.

Existing manufacturing processes have a large carbon footprint, being manufactured off-site before being transported to a filling facility.

### SUMMARY

In one aspect, there is provided a method for manufacturing a site-optimized storage container using one or more of the aspects described herein. In some embodiments, the method includes: for at least one waste product at an industrial site, obtaining location data and waste characteristic data; generating or obtaining parameter/characteristic data for a least one wastestream for the at least one waste product; based on the wastestream parameters and location data, determining at least one material for storing the waste; and generating an optimized container design based on the at least one material and storage facility data.

In another aspect, there is provided a site-optimized storage container manufactured with the design generated using one of more aspects of the methods described herein. In some embodiments, the storage container has an irregular hexagonal footprint.

In another aspects, there is provided a storage container kit include a digital record of the design considerations, testing and/or life span measurements of a particular storage container.

### BRIEF DESCRIPTION OF THE DRAWINGS

The preferred and other example embodiments are disclosed in association with the accompanying drawings in which:

FIG. 1 is a cross-sectional view of example cylindrical waste containers within a waste package.

FIG. 2A shows aspects of an example system for producing industrial waste containers.

FIG. 2B shows aspects of an example measurement, manufacturing or computing device.

FIG. 3 shows aspects of an example method for industrial waste containers.

FIG. 4 shows an example footprint or cross-section of a custom waste container.

### DESCRIPTION

Existing processes are centred around what is currently available and qualified, including repurposing containers designed for one wastestream for another wastestream, using containers designed for one facility to support storage in a different facility, using containers made of the materials available rather than those considered optimal or using containers qualified for one global region (e.g. North America) in another (e.g. Europe) without a full assessment of how it is impacted by different regulatory frameworks.

In some embodiments, aspects of the present disclosure provide systems and methods for on-site production of shape-optimized waste containers. In some embodiments, the waste containers are configured for storing radioactive waste. In some embodiments, the containers are generated using wire-arc additive manufacturing.

In safety critical industries, there are typically two approaches. One is the prescriptive approach, where what is required is tightly defined with no flexibility (e.g. USA) and the other is a permissive approach where there is a lot of scope for flexibility with a robust design justification within a few basic limits (e.g. UK). The former gives no choice and the latter leaves it open in an area where there are many competing design parameters: both make design decisions challenging. In some situations, aspects of the present disclosure may provide an algorithmic approach to the design of nuclear waste containers through a tool that generates one or more designs within a set of fundamental rules (e.g. minimum load limits, radioactivity exposure).

On top of this, existing design processes go through several review periods to select a shortlist of designs from a series of options. Design reviews are primarily focused on the structural behaviour and do not consider the layout or logistical considerations of storage facilities. Moreover, as described above, design reviews will consider containers that have already been qualified regardless of whether they are appropriate for the application in question, adding time and cost to the design review process. These will be streamlined by automation, where the logistical and structural considerations can be combined to quickly eliminate options at an early stage.

Traditional manufacturing techniques are possible with a large factory footprint, which scales with the number of designs to be produced. The cost similarly scales as producing moulds and other relevant equipment means that a unique production facility for each design is needed. With additive manufacturing, one factory cell can be used to produce multiple designs, thereby optimising the overall factory footprint as well as allowing a wide range of customisation to provide the more appropriate storage solution.

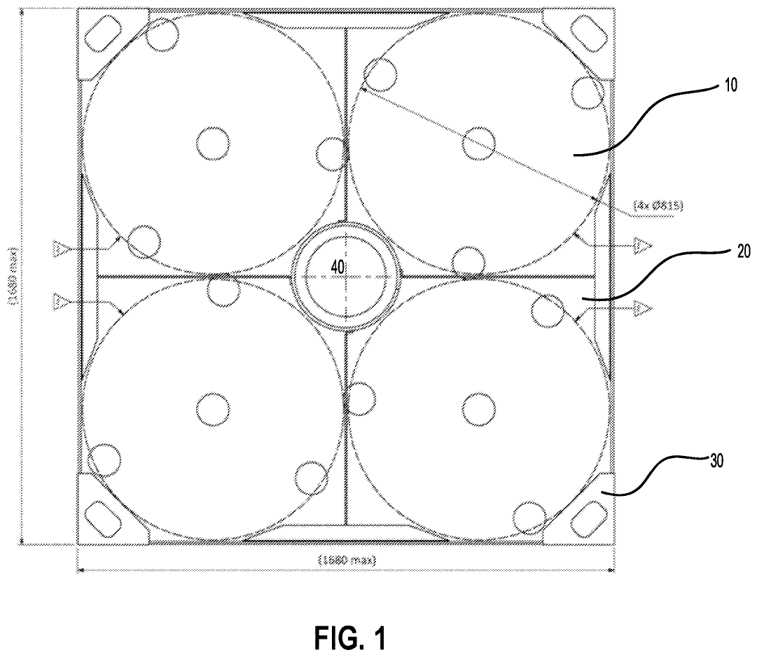

FIG. 1 is illustrative of one of the challenges, where cylindrical containers 10 are initially stored within a bigger package 20, with the package stillage (like a wine bottle carrier crate, but for waste containers). There is a lot of waste space because of the corner posts 30 and the central inspection port 40. This adds many millions of pounds to the waste storage solution depending on the waste to be contained and the total amount to be stored.

Finally, the regulatory Safety Case (UK term used for consistency, but terminology may vary depending on geographical area) for a nuclear component requires a lot of analytical work and assessments for documentation to demonstrate that it complies with regulations and is safe to use. This is in addition to the administrative documents, application forms, certificates and tracking information that is applicable to each container. These are often in a physical, paper form, creating problems of storage and traceability as they are required to
a. Have a physical storage location;
b. Be directly relatable to the relevant container and/or design;
c. Be secure and maintain quality for the lifetime of a waste container (>100 years).

The ability to produce a custom-designed waste container that is optimised for the storage space and maintains a secure, robust digital record is therefore beneficial to the industry in several ways.

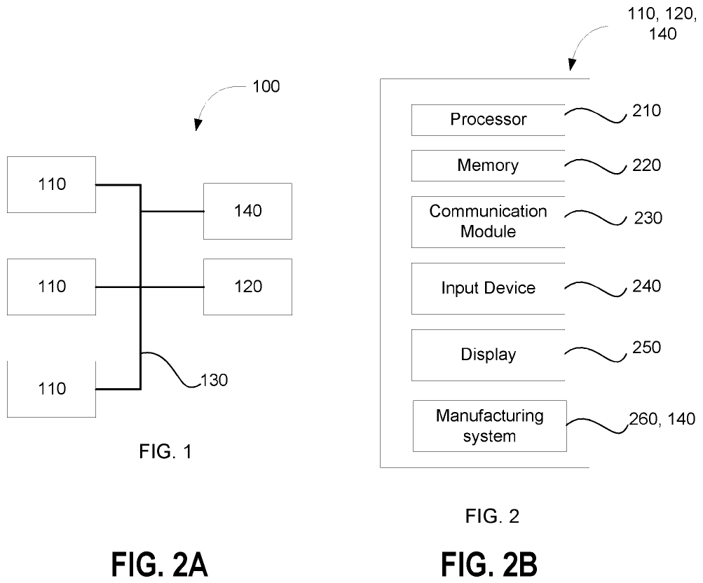

FIG. 2A shows an example system 100 for producing industrial waste containers. In some examples, aspects of the system can be used to help generate custom waste containers based on observed/measured waste and location characteristics. Aspects of the example systems can, in some examples, be a component of a larger process for waste containment and storage.

In the example shown, system 100 includes one or more measurement devices 110 with which location data and/or waste characteristic data can be obtained. In some embodiments, the measurement devices can include laser, ultrasonic or other distance measurement sensors. In some embodiments, the measurement devices can include temperature, humidity, toxicity, pH, radiation and/or any other type of environmental sensors. In some embodiments, the measuring devices can include lidar or other sensors for detecting the (3D) size and/or shape of the waste, the environment (e.g. geographic location/surrounding obstacles/objects of the location/surrounding area/along the exit path of the waste, surrounding objects/obstacles/exit path of a transportation mechanism and or the storage facility. In some embodiments, the measurement devices can include material composition sensors. In some embodiments, the measurement devices can include one or more data storage device on which schematics, blueprints, chemical/material composition characteristics, and/or any other location and/or waste characteristic data which was previously measured/generated has been stored. In some embodiments, the measurement devices can include data storage device(s) on which databases storing material data such as characteristics of different materials/waste products and/or storage containers, for examples, reactivity, types of radiation, heat generating capabilities, chemical phases, storage material characteristics (strength, reactivity, heat dissipation, corrosion resistance, etc.), safety/regulatory/storage requirements, and the like. In some embodiments, the measurement devices can any combination of the above-listed devices and/or other devices for obtaining the characteristics which may be used to generate the container design.

In some examples, the measurement devices 110 can be connect to a computing device 120. The computing device 120 can, in some examples, be a server or separate computing device for performing computations for, generating designs, and/or sending instructions for/controlling the manufacturing process. It can also include software applications or modules for performing various aspects of the container generation system.

In some embodiments, an example industrial waste container system can several measurement devices 110 which measure or otherwise obtain different data. In some examples, the measurement devices 110 and computing device 120 can be at different locations such as remove or handheld devices in different locations or a server or database hosted at a remote location. Data can be communicated between devices via network(s) 130. The network 130 can include one or more private and/or public networks. The network 130 can include a wired network such as a wired local area network or the internet, direct link, or wireless networks such as cellular telephone networks, Bluetooth or Wi-Fi networks. In some embodiments, the network 130 can include any communication channel over which data can be communicated including wires, vias or other communication means within a single device.

In the example shown, system 100 includes one or more manufacturing systems 140. In some embodiments, the manufacturing systems can include an additive manufacturing system such as an arc-base additive manufacturing system, a 3D printing system, and/or any other manufacturing system which can receive a custom container design and manufacture the container(s). In some embodiments, the manufacturing system(s) 140 are set up at the site of the waste. In other situations, the manufacturing system(s) can be set up nearby or at an operationally efficient location based on the location of the manufacturing inputs, energy inputs, availability of transportation and/or location/characteristics of the waste.

While the example system shows three measurement devices, one manufacturing system and one computing device, any number of measurement, manufacturing or computing devices can be used in any suitable arrangement.

In some examples, the computing device 120 can host or have access to a database storing material, storage and/or waste information. In some examples, the computing device 120 can provide processing or host an application or software module accessible by a client device for performing various aspects of the methods described herein.

In some examples, the computing device 120 itself may also be or may be part of a measurement device 110 and/or a manufacturing system 140. For example, a manufacturing device or measurement device can include a processor which can perform computing aspects of the process(es) described herein.

In some examples, the system can include a database located at a client device 110, a central device 120, or elsewhere on the network. The database can, in some examples, store waste, material, location, facility, and/or regulatory information. In some examples, local or backup copies of orthodontic information can be stored at a multiple locations including a measurement device 110, a computing device 120, a manufacturing system 140 or elsewhere in the system.

Examples of measuring 110 and computing devices 120 can include, but are not limited to, computers, servers, tablet or mobile computers, or mobile phones, which can have one or more attached or peripheral devices (e.g. input devices, sensing systems, measuring devices, etc.).

FIG. 2B shows aspects of an example measurement 110, manufacturing 140 or computing device 120. The device 110, 120, 140 can include one or more processors 210 connected to one or more memories 220, communication modules 230, input devices 240, or displays 250. In some embodiments, the device 110, 120 can include one or more manufacturing systems 140, 260.

In some examples, a memory 220 can store modules which enable a processor 210 to perform any aspect of the methods described herein. In some examples, a memory 220 can store waste, location, transportation, material and/or regulatory information.

In some examples, a device 110, 120 can include a communication module 230 which may include hardware or software for communicating data or instructions over network 130.

In some examples, a device 110, 120 can include or be connected to one or more input devices 240 for receiving inputs to adjust parameters, perform design selections, control the processes, or to otherwise operate the device 110. Input devices can include keyboards, mice, touchscreens, touchpads, navigation devices, remote controls, tablet computers, mobile phones, or other suitable input devices. These devices may be integrated, connected, peripheral, or any other suitable type of device.

In some examples, a device 110, 120, 140 can include or be connected to a display 250 for displaying aspects of the manufacturing process.

In some examples, computer-readable instructions such as a computer program or application can be installed or otherwise operable on a client or central device, or can be stored on a non-transitory, computer-readable medium.

In some examples, when measurement or other information is stored at one device, it can be accessed by different users at different locations or on different devices.

The system 100, in some examples, provides a digital design environment in which aspects of the system can be used to create, store and/or manufacture container designs.

In some examples, one or more devices 110, 120 and/or one or more of their processor(s) 210 can be configured to performed any aspect(s) of the methods described herein.

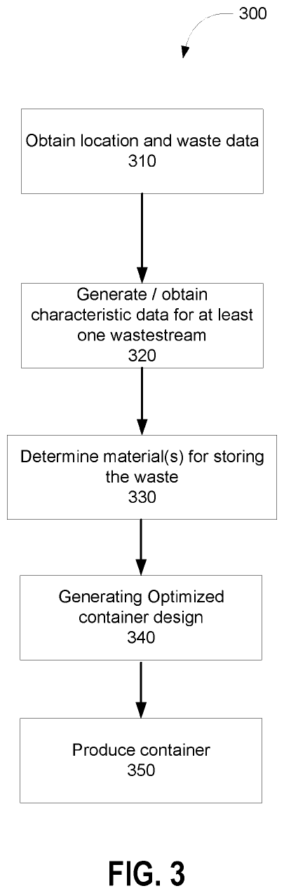

FIG. 3 is a flowchart showing aspects of an example method 300 for a site-optimized storage container. These flowcharts show example operating sequences of example system 100; however, it is to be understood that aspects of different flowcharts can be combined or can be performed in any suitable order. In some embodiments, various aspects of the method can be performed on a single processor/device/system; however, in others, aspects of the method can be performed by different processors/devices/systems.

At 310, one or more processors are configured to obtain location data and waste characteristic data. As noted below, in some embodiments, the obtained data can include data regarding the layout of the storage facility (e.g. blueprints, maps, exit or potential exit dimensions or other waste routes and any structural/spatial limitations along that route).

In some embodiments, the obtained data can include measuring, detecting, observing, accessing or otherwise obtaining data regarding the type of waste to be contained. This can include but is not limited to sizes, weight/mass, radioactive properties, heat generating properties, state (solid, liquid, gas), corrosiveness, toxicity, venting, reactivity, chemical make up, etc.

In some embodiments, the obtained data can include geographic location data and/or relevant regulations of the jurisdiction in which the waste is location and/or to be stored.

In some embodiments, the obtained data can include filing requirements. For example, this can include waste material size, ability to be safely reduced/fragmented, conversion into a wastestream (e.g. storing in a mixture such as molten glass, concrete, etc.).

| Input | Outputs |
|---|---|
| Storage facility | Containment options |
| Type of waste to be contained | Candidate materials |
| Geographical location | Relevant regulations |
| Total amount of waste | Container size, packing |
| to be contained | |
| Filling requirements | Aperture size, filling strategy, |
| | filling features |
| Size and shape of each | Aperture size, container size, |
| portion of waste | container shape |
| Chemical make-up of the waste | |
| (Toxicity, reactivity, venting) | |
| Criticality requirements | Container size, container shape, |
| | container thickness |
| Shielding requirements | Materials, container size, |
| | container thickness |
| Loading requirements | |
| Heat dissipation requirements | Surface condition, cooling |
| | features, materials |

In some embodiments, the processor(s) obtain a design with the overall space limitations governing the storage facility. This can allow the limitations of the storage facility to be defined in a manner that is compatible with computer-based processes. The design can be provided via a CAD file either derived from a manually modelled process or using laser scanning hardware, creating a digital shadow of the facility.

The electronic design can be transformed into a set of data points that capture the layout of the facility, including all obstructions (staircases, walkways) and other geometric features.

At 320, the processor(s) are configured to generate/obtain characteristic data for at least one wastestream.

In some situations, there can be several radioactive waste streams, including solid and liquid waste as well as wastestreams encapsulated in glass or concrete. The wastestream of interest will be processed and analysed to produce a number of inputs for the algorithm. These inputs, and their associated outputs, will include:
a. Chemical phase (e.g. solid, liquid, sludge, resin);
b. Reactive substances (e.g. acids, chelating agents);
c. The type of radiation present;
d. Heat generating capabilities.

In some embodiments, the processor(s) are configured to generate characteristic data for sludges or resins which may be a mixture of different types of waste, while solid waste can have different unit sizes.

At 330, the processor(s) are configured to select an appropriate material for storing the waste based on the wastestream parameters and the location data.

Example 1: if vitrified waste was selected as an input, the tool might recommend 316L as a material due to its good all-round structural and chemical performance. However, if there were corrosive chemicals in liquid form then it might recommend a duplex stainless steel due to its greater pitting and corrosion resistance. By analysing the specific region, this recommendation can be cross-referenced against the appropriate regulatory documents to ensure that the alloy recommended is likely to be qualified.

Example 2: if the storage location had a high humidity and above average salt content, the tool might recommend a duplex steel due to the increased risk of stress corrosion cracking.

At 340, the processor(s) are configured to generate a container design based on the at least one material and the storage facility data.

In some embodiments, the processors utilize output from previous steps to generate a container cross-section or ‘footprint’ that will optimise the packing density of the containers within the facility in 2D. In some embodiments, the cross-section is defined at least in part on the size of the waste, any limiting size factors along the path of the waste to the storage facility (e.g. doorways, exit paths from facility in which the waste is located, transportation limitations and storage facility requirements).

In some embodiments, the processor(s) are configured to generate a proposed path of the waste from its original location, out of the facility/environment in which the waste is located, via any transportation, and to the proposed storage facility. In some embodiments, the processor(s) are configured to determine the most restrictive size-limiting factor long that path to determine the size/design of the container. In some embodiments, the processor(s) are configured to generate the container based on the a combination of any of the factors described herein or otherwise. The below provides some non-limiting factors.

Example 3: if minimum and maximum container widths are specified (e.g. between 1 m and 2 m), the container cross-sections that are optimum from a packing efficiency perspective are suggested.

Example 4: If the wastestream is a high heat generating waste the tool can calculate a surface to volume ratio that would be ideal for the container. It could also recommend the following design options:
A square cross-section to improve heat dissipation to the surroundings instead of a circle or hexagon as for the same height and volume, it has a higher surface to volume ratio;
More space between containers may be suggested to ensure that heat generated is dissipated to the surroundings and does not affect surrounding containers;
Features such as ribs and fins that can assist with heat dissipation by increasing the surface to volume ratio.

Example 5: If the wastestream is solid waste with a maximum size of 300 mm, a container design will be generated with a mouth that can fit it.

Example 6: If the wastestream is solid waste that can be laser scanned, an arrangement is proposed that stacks pieces together to optimise how the space is used within the container.

Example 7: If the wastestream contained waste with a radioactivity level beyond a certain threshold, the tool can propose an appropriate container thickness depending on the shielding provided by the facility.

Example 8: If the wastestream produces gaseous emissions, the tool will propose vents to prevent the pressure from building up inside the container.

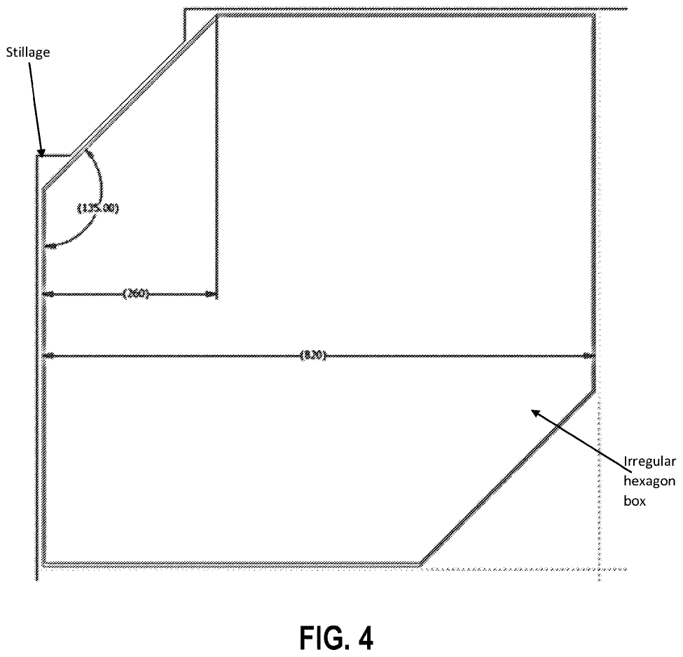

Example 9: The facility is designed to store individual containers within waste packages that have central inspection ports and structural posts at the corner (see FIG. 1). The tool can propose a more space efficient design, such as the one in FIG. 4.

Example 10: A square is the most optimal design shape, however its corners could act as a stress concentration. The tool recognises this as an issue and applies a smooth profile to the corners, which would be more difficult using conventional manufacturing.

Example 11: The user would like to avoid sharp corners altogether and specifies a minimum and maximum corner angle, which is used to generate an optimal design shape that complies with this restriction.

FIG. 4 shows an example irregular hexagon waste container within a single quadrant of a waste package that is more efficient for space compared to FIG. 1 and can incorporate corner posts and a central inspection port.

In some embodiments, the container design is generated as a 3D CAD model, which can be generated from the optimal storage container footprint. In some embodiments, the processor(s) are configured to simulate and generate containers dimensioned and stress tested for stacking within the 3D space of the facility and/or storage location. After this point, details such as vents, lids/fasteners, mechanical handling features or serial numbers and tracking details are may be added by the processors.

A basic, automated analysis of the structure is performed using the CAD file produced to ensure it can withstand some of the basic load cases it is subject to. Using data extracted from the CAD model (e.g. surface area, volume), the basic load cases are applied to the designs to eliminate and information about the bulk stresses and strains can be calculated. This can give an immediate assessment about whether the container is suitable or not for the application chosen and therefore automatically eliminate concepts from consideration.

Example 12: Based on the vertical space available, in an example situation, the optimal logistical solution may be to stack the containers 10 high. However, the density of the wastestream may limit the weight bearing capacity of the material selected, meaning a solution of thicker walls will be counterproductive. In some embodiments, the processors utilize an iterative procedure to find the ideal weight to size ratio that can balance the waste storage, geometric efficiency and structural capability with a material suited to the defined wastestream.
Output 1: A build strategy, including
   a. Process parameter windows (e.g. feed speed, arc voltage, arc current, wire bead size) that would provide the best build for the application;
   b. The order of manufacturing different features.
Output 2: NDT (non-destructive testing) strategy, including
   a. What are the governing regulations around inspection;
   b. What method of NDT is needed;
   c. Instructions on which features/areas need inspection;
   d. What parameters are to be used for inspection.
   e. Forecast costs and value

Using supply chain and operational data, a cost per container is calculated. This will be extrapolated to the full storage solution cost for the facility based on the number of containers required.

Example 13: If the wastestream is low activity waste with a small total waste volume, the tool may recommend using a container manufactured by conventional methods e.g. rolled steel drums. The processors can also propose the break-even point where the total waste stored and the type of container required makes it economically beneficial to use additive manufacturing.

Additive manufacturing can be more energy efficient, consumes less raw material and can be deployed locally where required, reducing supply chain emissions and bringing many non-financial benefits to the production process. This is a key driver in some geographical locations and the design tool can calculate some of these quantities in real-time using available data.

Example 14: The container is to be used in the UK, where government procurement is subject to Social Value (Procurement Policy Note 06/20) and Carbon Reduction Procurement Policy Note 06/21) procurement policies within proposals. The amount of carbon emissions associated with an equivalent, conventionally manufactured design are calculated through estimating the likely energy expenditure and material wastage in production and transport, while the Social Value component can be calculated by using statistical data available online to estimate the benefits gained to the local community through localised production. These calculations are added to the digital shadow and can form the basis of grant applications for government funding and/or add justification for the superiority of an AM container design.

### Design Details

At this stage, the aforementioned fine details recommended by previous stages are implemented into the design. Any other customisations that are required are inserted here to produce a final portfolio of CAD files that are attached to the digital shadow of the design.

Features and stress concentrations can be used in conjunction with 3D CAD data to identify where inspections need to focus on.

### Detailed Substantiation

The CAD files are imported to a Finite Element (FE) model and the governing regulatory load cases are applied to the design. Relevant results of the analyses are extracted from the models, with additional calculations applied using software tools and algorithms before being compiled into data files. The data files are then attached to the design's digital shadow and particular problem areas are highlighted for analyses.

It will also suggest
a. Areas where properties can be tuned for performance, which is one of the advantages of AM (additive manufacturing);
b. Areas where the use of multiple materials are needed, which is another advantage of AM;
c. Problem areas such as stress concentrations based on design best practice.

Example 15: When storing certain kinds of solid, unencapsulated waste like metal, the internal surface of the container may need to be harder to resist abrasion while not being subject to the same impact loads as the outside, which needs to be more fracture resistant. The process parameters can be defined

Example 16: A small, non-structural part of the container is likely to encounter more stress-corrosion cracking than the rest of the container. The process parameters are adjusted for a duplex steel in this area while the rest of the container remains an austenitic steel like 316L. Duplex steels are more difficult to control from a process perspective, but much more resistant to SCC than austenitic steels.

Example 17: The FE analyses highlight regions experiencing strains beyond acceptable limits. These are extracted along with 3D location information on the CAD file to direct where NDT inspections need to focus on.

In some embodiments, the analyses files that make up the Safety Case are compiled and stored in a database (i.e. the digital shadow). In some embodiments, the digital shadows for each manufacturer container are stored in conjunction with one more identifiers which are mapped to a tag or other identifier printed on, embedded in or otherwise associated with the container.

At 350, one or more storage containers are manufactured or otherwise produced using the generated container designs (e.g. CAD files). In some embodiments, the processor(s) are configured to send the designs to the manufacturing device. In some embodiments, the processor(s) are configured to instructor or otherwise control aspects of the manufacturing systems to manufacture the container(s).

Example 18: The design tool and the machine are in different locations. However, both are connected to a cloud-based storage system meaning that the CAD files can be uploaded from anywhere and is therefore compatible with remote/hybrid working.

### Non-Destructive Testing

A robot head with NDT testing as specified in Ultrasonic testing is used for quality assurance to verify the quality of the produced container. This occurs simultaneously to production and is used in conjunction with other monitoring systems for key parameters, which are monitored to ensure they are within the defined parameter windows. Temperature measurements can be made using pyrometers or thermocouples and the melt pool can be photographed using a camera. Image processing software assesses the melt pool shape.

Expected windows for WAAM parameters and temperature readings are used together and data points are flagged red, amber and green. Green means it is within the window, amber means that the process is paused and the location is investigated using NDT before resumption and red means that production is stopped and a repair is needed. This is unlike conventional manufacturing, where problem areas are not highlighted until after the part is completed and repairing is more difficult.

A record of all results is generated and appended to the digital shadow. In some embodiments, the digital shadow (e.g. database record) for each container can be maintained and updated throughout the design, testing, qualification, manufacturing, filling, transporting, storage, periodic checking, and/or other phases of the container life.

In some embodiments, basic information about the container has been entered by the user during the above process, meaning the general qualification documents are automatically generated within a specified template.

Geometric and material data pertaining to storage are calculated and so automatically entered into data sheets.

Design justifications and analysis data are electronic and can be appended to the files to demonstrate that they satisfy the load cases.

CAD portfolio generated is appended automatically, clearly defining the design to be certified electronically.

Production instructions and an NDT definition are electronic and defined for the qualification process, which can be used in any cloud-connected machine remote from the design process.

Production measurements of process parameters are compiled along with associated location and build history to clearly show that the process has been made within the qualification requirements.

Non-financial data (Social Value, Carbon Reduction) is generated and added to the design justification documents.

All the above are compiled into the container's digital shadow. The application for qualification of the container is now ready for submission.

While the foregoing invention has been described in some detail for purposes of clarity and understanding, it will be appreciated by those skilled in the relevant arts, once they have been made familiar with this disclosure, that various changes in form and detail can be made without departing from the scope of the invention. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect or import of the methods described.

1. A method for manufacturing a site-optimized storage container, the method comprising:
for at least one waste product at an industrial site, obtaining location data and waste characteristic data;
generating or obtaining parameter/characteristic data for a least one wastestream for the at least one waste product;
based on the wastestream parameters and location data, determining at least one material for storing the waste; and
generating an optimized container design based on the at least one material and storage facility data.

2. The method of claim 1, comprising: manufacturing the site-optimized storage container based on the optimized container design.

3. The method of claim 1, comprising: generating the optimized container design based on path data of the at least one waste product's original location at the industrial site to a storage facility.

4. The method of claim 1, comprising: generating a digital shadow for the site-optimized storage container, the digital shadow including the optimized container design and container design analytic data.

5. The method of claim 4, comprising: updating the digital shadow to include manufacturing data for the specific container.

6. The method of claim 4, comprising: conducting non-destructive testing on the storage container, and adding non-destructive testing data to the digital shadow.

7. A site-optimized storage container manufactured with the design generated using the method of claim 1.

8. The storage container of claim 6 having an irregular hexagonal footprint.

9. The storage container of claim 5 wherein the container is dimensioned to reduce a storage footprint when positioned adjacent to a plurality of additional storage containers.

10. A qualified storage container kit, comprising a site-optimized container and at least one non-transitory computer-readable medium having stored thereon a digital shadow for the site-optimized container.

11. A system for manufacturing a site-optimized storage container, the system comprising:
at least one measurement device for obtaining location data and waste characteristic data for at least one waste product at an industrial site;
at least one processor configured for:
generating or obtaining parameter/characteristic data for a least one wastestream for the at least one waste product;
based on the wastestream parameters and location data, determining at least one material for storing the waste; and
generating an optimized container design based on the at least one material and storage facility data.

12. The system of claim 11 comprising:
at least one manufacturing device for manufacturing a container based on the optimized container design.

13. The system of claim 11, wherein the at least one processor is configured for: generating the optimized container design based on path data of the at least one waste product's original location at the industrial site to a storage facility.

14. The system of claim 11, wherein the at least one processor is configured for: comprising: generating a digital shadow for the site-optimized storage container, the digital shadow including the optimized container design and container design analytic data.

15. The system of claim 14, wherein the at least one processor is configured for: updating the digital shadow to include manufacturing data for the specific container.

16. The system of claim 14, wherein the at least one processor is configured for: conducting non-destructive testing on the storage container, and adding non-destructive testing data to the digital shadow.
